(19) United States
(12) Patent Application Publication
(10) Pub. No.: US 2003/0223054 A1
(43) Pub. Date: Dec. 4, 2003

(54) Method and apparatus for identifying gemstones

(75) Inventor: Malcolm Raymond Warwick, Vancouver (CA)

Correspondence Address: Susan M. Ben-Oliel, 2983 West 41st Ave., Vancouver, BC, V6N3C8, CA

(73) Assignee: NATURAL CRYSTAL INFORMATION SYSTEMS

(21) Appl. No.: 10/159,791

(22) Filed: May 29, 2002

(51) Int. Cl. G01N 21/87

(52) U.S. Cl. 356/30

(57) ABSTRACT

An apparatus for obtaining information about inclusion geo-spatial orientation within a gemstone comprises a means to measure the distance to and location of one or more selected inclusions within said gemstone relative to one or more points of assessment situated on or within said gemstone; and a monitoring system for collecting, compiling and analyzing data on the same.

### FIELD OF THE INVENTION

This present invention relates generally to a method and apparatus for identifying and tracking gemstones, particularly diamonds, which method enables each gemstone to be uniquely identified and verifiable from rough to polished as compared to any other gemstone.

### BACKGROUND OF THE INVENTION

Identification of gemstones, and in particular diamonds, is an issue that has attracted much attention over the past decade. They are highly valued commodities in both rough (i.e. uncut or unpolished) form and finished or polished form. They may be easily transported, sequestered and exchanged. Tracking a gemstone from rough to polished is especially difficult as the structure of these objects can be superficially altered by techniques such as re-polishing, re-cutting, and irradiation. Nonetheless, such tracking would be of immense benefit to governments, mining companies, gemstone manufacturers, wholesalers, jewellers, insurance companies and the public.

A discussion of the geopolitical issues surrounding this need to document the chain of custody and origin of “conflict diamonds” i.e. diamonds which have been mined or otherwise obtained by insurgency movements to finance the purchase of arms and supplies, may be found in a publication entitled “Conflict Diamonds: Possibilities for the Identification, Certification and Control of Diamonds”, published in June 2000 by the organization Global Witness. This article describes the structure of the international diamond market, the difficulties which exist in determining the origin of diamonds and currently known technology for the identification of diamonds. Although certain identification methods are known, and are described below, they primarily require expert examination of the gemstone in question. Such examination typically involves considerable time and expertise and may yield inconclusive results. A reliable, relatively simple, tamper-resistant method, which does not harm the gemstone heretofore has been unavailable.

Many known diamond identification techniques involve “fingerprinting” the easily recognizable features of a diamond. Such features include the carat weight, cut, clarity and colour. Other techniques rely on physical characteristics of a diamond, including the measurement of surface irregularities using Nomarski differential interference contrast or techniques measuring bulk average properties eg. fluorescense, magnetic, optical absorption and electron spin resonance measurements. These techniques, while useful, become less so if a diamond has been altered as described above. Furthermore, most fingerprinting techniques can only be performed on cut and polished diamonds, not rough stones.

By way of example, gemstone identification based on reflection techniques is illustrated in U.S. Pat. Nos. 3,740,142, 3,833,810, and 3,947,120. Gemstone identification based on geometric scattering techniques is illustrated in U.S. Pat. No. 4,012,141. Gemstone identification based on Raman refraction techniques is illustrated in U.S. Pat. No. 4,799,786. Gemstone identification based on ion implantation techniques is illustrated in U.S. Pat. Nos. 4,200,506 and 4,136,385. Gemstone identification based on laser micro-engraving techniques is disclosed in U.S. Pat. No. 4,467,172 and Israel Patent No. 64274. Gemstone identification based on x-ray techniques is illustrated in U.S. Pat. Nos. 4,125,770 and 4,900,147.

Additionally, the following techniques in this and related fields have been developed and either patented or are the subject of pending published applications: U.S. Pat. No. 5,118,181 describes the use of luminescence radiation uniformly distributed by a light-diffusing surface to characterize a gemstone. U.S. Pat. No. 5,418,829 describes a method of identifying a crystal structure by means of radiating two corpuscular beams or electromagnetic waves. U.S. Pat. No. 5,118,181 employs a technique of exciting a gemstone causing it to emit a unique luminescence spectrum. U.S. Pat. No. 4,143,544 uses a technique of measuring growth discontinuities in the crystal structure of a gemstone. In particular, the crystal structure is analyzed by a technique based on the triboelectric effect or static electricity of the diamond. U.S. Pat. No. 5,077,767 describes a system of identifying a crystal by the existence of mis-orientations (wherein one or more volumes of the crystal have a different crystallographic orientation relative the remainder). This is achieved by irradiating the full depth of the crystal with a beam of substantially parallel incident x-rays. PCT Publication WO 02/10091 describes a gemstone tracking system which contemplates that the rough stones would have a polymer coating placed thereon, effectively sealing them from tampering until a subsequent stage of the manufacturing process. Within this polymer coating there would be an identification tag in the form of a label, logo, transponder, microchip, hologram or the like.

Arguably one of the best known identification systems today is marketed by Gemprint Corporation and is disclosed, for example, in U.S. Pat. Nos. 5,124,935 and 5,828,405. Generally, this technology involves the recordal and storage of information relating to the unique light pattern of each gemstone.

The Gemprint system, which is commercially available, allows the comparison of a first optical response with a second optical response and allows both of these responses to be displayed on a computer monitor and appropriately rotated and overlayed. The computer system provides a comparison of the two optical records. The final determination of a match is often confirmed by a skilled person comparing the two optical responses.

This optical response of the gemstone is influenced by the position that the gemstone is secured in within the image recording apparatus and any misalignment of the gemstone distorts the optical response. It may also be necessary to rotate and correct the image for distribution to compare one optical response for a gemstone with a previously recorded optical response of the gemstone.

Other drawbacks of the Gemprint system include the fact that, if a gemstone is altered, for example, re-cut, as may happen in the case of a stolen gemstone, the profile originally obtained would be of little or no value. In addition, the analysis is conducted only on finished or polished gemstones and not on the rough product. What is required by the industry is a verifiable system which may be used uniformly to identify and track a gemstone from rough to polished, such system being unaffected by any alterations to the gemstone such as cutting, polishing, re-polishing, re-cutting, and irradiation.

Due to the conflict diamond issue, there is clear momentum internationally to develop a means to identify diamonds by “source”. The Canadian government, along with the Royal Canadian Mounted Police, are investigating ways to protect its' nascent diamond industry i.e. to identify Canadian mined diamonds as being distinct from those mined in other regions. One possible method under investigation is an analysis of the chemistry of the imperfections in the diamond. Although diamonds are nearly pure carbon, less than one twentieth of one percent do constitute other trace minerals. The profiles of these minerals are unique and differ from source to source. By spectrometry analysis of a range of diamonds from each source or region, a profile of impurities could be used by inspectors. The significant drawback of this system is in the collection and accuracy of data collected. An inspector would require samples from every diamond region in the world in order to create a reliable database. Countries such as Angola and Sierra Leone would need to provide clean accurate samples of their diamonds for analysis. Legitimate mining companies would also have to fully participate in the program and furnish samples of their rough which they may be reluctant to do because the full range of stones produced by each mine is often considered proprietary information.

It is an object of the present invention to obviate or mitigate the disadvantages of these prior known gemstone identification and profiling techniques.

### SUMMARY OF THE INVENTION

The present invention provides, in one aspect, an apparatus for obtaining information about inclusion orientation within a gemstone comprising:

a) a means to measure the distance to and location of (the geo-spatial co-ordinates of) one or more selected inclusions within said gemstone relative to one or more points of assessment situated on or within said gemstone; and

b) a monitoring system for collecting, compiling and analyzing data provided by a).

The present invention provides, in another aspect, an apparatus for obtaining information about inclusion orientation within a gemstone comprising:

a) a laser for generating an output beam;

b) a scanning system wherein the laser beam is moved over one or more points of assessment on or within the gemstone or the gemstone is moved spatially to align one or more points of assessment with the output beam; and

c) a monitoring system for automatically reviewing data from the laser, said data providing geo-spatial co-ordinates of one or more selected inclusions relative to the points of assessment, said monitoring system measuring the distance to and location of each selected inclusion.

In yet another aspect, the present invention provides an apparatus for obtaining information about inclusion orientation within a gemstone comprising:

a) at least one galvanometric scanner capable scanning the gemstone through one or more defined points of assessment on or within said gemstone by minute depth increments using a focussed laser beam deflected in two perpendicular planes;

b) photomultiplier to detect electromagnetic energy irradiated by the scanned gemstone in the form of electrical signals; and

c) a means to digitize the electrical signals, thereby creating a profile of selected inclusions within said gemstone, said profile representing the orientation of each inclusion relative to the point of assessment.

In yet another aspect, the present invention provides a method of creating a unique identification profile for a gemstone, which profile may be used to track the gemstone from rough to polished, comprising the steps of:

a) measuring the distance to and location of (the geo-spatial co-ordinates of) one or more selected inclusions, within said gemstone relative to one or more points of assessment on or within said gemstone; and

b) collecting, compiling and analyzing data on the orientation of the selected inclusions thereby forming an identification profile.

In yet another aspect, the present invention provides a recorded profile, model and survey of a gemstone whenever produced by the methods described herein.

What is provided by the apparatus and method of the present invention is an accurate and completely verifiable means to identify a gemstone from rough to polished through the creation of a “profile”, “model” or “survey” of selected inclusions. These inclusions are specifically surveyed relative to a selected point of assessment. The veracity of this method is not compromised, even if the rough gemstone is cut and polished i.e. the polished stone may be traceable back to the profile of the original rough crystal. Likewise, with respect to diamonds, polished top and bottom moieties may be traced back to the original rough “parent” using this method. Within the scope of the present invention, specific inclusions and a survey thereof become the mark of authenticity of a gemstone thereby distinguishing the stone from synthetic counterparts. In other words, the complex geology and chemistry of such inclusions is capitalized upon and utilized.

It is suspected that this technology will be especially useful for mining companies, governments, gemstone manufacturers and wholesalers which are under unabated international pressure to provide a means by which each gemstone, particularly diamonds, can be marked and traced from source to sale.

These and other significant advantages will become apparent below.

### BRIEF DESCRIPTION OF THE DRAWINGS

The present invention is illustrated by way of the following non-limiting drawings in which:

FIG. 1 is a schematic view of one embodiment of an apparatus of the present invention;

FIG. 2 is a schematic view of another embodiment of an apparatus of the present invention;

FIG. 3 illustrates a gemstone showing selected inclusions and selected points of assessment;

FIG. 4 illustrates a gemstone showing selected inclusions, selected points of assessment and the x-y-z (Cartesian) co-ordinates of the same.

### PREFERRED EMBODIMENTS OF THE INVENTION

The following detailed description is provided to aid those skilled in the art in practising the present invention. However, this detailed description should not be construed so as to unduly limit the scope of the present invention. Modifications and variations to the embodiments discussed herein may be made by those with ordinary skill in the art without departing from the spirit or scope of the present invention.

According to one embodiment of the present invention, there is provided a method of obtaining a unique identification profile of a gemstone based on the orientation of a selected number of inclusions within the gemstone relative to at least one point of assessment. While this method is especially relevant and useful for diamonds, it is to be understood that it may be applied equally well to other gemstones, including, but not limited to emeralds, rubies, sapphires, and the like. The creation of the profile in accordance with the present invention may occur at any stage of processing the gemstone from rough to polished. However, in a most preferred form of the present invention, the original profile of a gemstone is created as a first step of manufacturing from rough i.e. prior to cutting/sawing and the downstream steps.

Generally, inclusions can be defined as inhomogeneities in the crystal structure of a gemstone and often constitute trapped minerals. With respect to diamonds specifically, they can be explained as follows: The process of diamond growth in the interior of the earth did not occur evenly, but in several phases. In these various phases, the conditions of temperature, pressure and cooling did not always remain constant. As a result, inhomogeneities occurred which are now found as these internal features called inclusions. Research over the years has determined that there are three basic types of inclusions: those present before crystallization of the diamond and were enclosed it in (pre-existent inclusions), those which were formed at the same time as the diamond (syngenetic inclusions) and those which developed subsequent to crystal formation (epigenic inclusions). The latter includes cracks resulting from stress due to temperature and pressure changes or because of irregular cooling.

About twenty-five minerals are known as inclusions in diamonds, the most common being reddish garnet, brown spinel, green enstatite and diopside as well as dark brown to black ilmenete and magnetite. Much more information about the nature of inclusions in diamonds and other gemstones can be found in the book “Photo atlas of Inclusions in Gemstones” by Gubelin/Koivula. Within the scope of the present invention, “inclusion” means all internal faults and features which are completely or partially surrounded by a gemstone, including, but not limited to: crystalline or solid inclusions, negative crystals (areas in which crystal structure formed but subsequently “melted” thereby leaving a hole within the crystal structure), clouds, dot-like inclusions, cracks, feathers or fan-like inclusions and fringes on the girdle.

Commercial use of diamond inclusions as a measure of value began in Paris in the early part of the 1900's and was continued in the US by the Gemological Institute of America (“GIA”) through the development of uniform gradual quality designations for “clarity” based on the number and size of inclusions. At the same time, the 10× magnification was established as a standard power through which inclusions are viewed and noted. Later, this 10× magnification was accepted internationally for clarity grading. Clarity designations range from flawless (internally flawless, loupe clean) to very, very slightly imperfect (VVSI) to very slightly imperfect (VSI) to slightly imperfect (SI) to imperfect 1-3. If a diamond is graded as “internally flawless”, it is free from internal faults under 10× magnification. However, it is be to recognized that gemstones, including diamonds, are never entirely free from inclusions, and it is only a question of the magnification used whether they can be discerned or not. It should also be appreciated that no two gemstones are alike in their inclusion profile. In essence, a map or survey of the inclusions in a gemstone is as unique and identifiable as a fingerprint.

Within the scope of the present invention, one or more selected inclusions are surveyed and analyzed in much the same way as land surveyors survey parcels of land. In essence, selected inclusions are chosen (like claims posts on land) and their orientation characteristics targeted relative to pre-selected position(s) (in the case of the present invention, one or more “points of assessment”, one of which is the co-ordinate origin as defined further below), so that each may subsequently be used uniquely to identify the gemstone. Using the same triangulation techniques as employed in the land surveying trade, one may extrapolate the location of a “missing” inclusion by the orientation of the remaining chosen inclusions. Likewise, the location of a “missing” point of assessment may also be determined by triangulation.

Analysis of the Apparatus

The core of the apparatus of the present invention is a means to measure the distance to and location of (the “geo-spatial point analysis”) one or more selected inclusions within a gemstone relative to one or more points of assessment situated on or within said gemstone. Such measurement may be achieved by several means wherein radiant energy, within the electromagnetic spectrum, is used to irradiate the gemstone and energy emitted, irradiated or reflected is used to profile selected inclusions.

Direct Electromagnetic Energy Transmittal Apparatus

In general, this apparatus comprises a laser for generating an output beam; a scanning system wherein the laser beam is moved over one or more inclusions and points of assessment on the gemstone or the gemstone is moved spatially to align one or more inclusions and points of assessment with the output beam; and a monitoring system for automatically reviewing data from the laser, said data providing co-ordinates of one or more selected inclusions relative to the points of assessment, said monitoring system measuring the distance to and location of each selected inclusion.

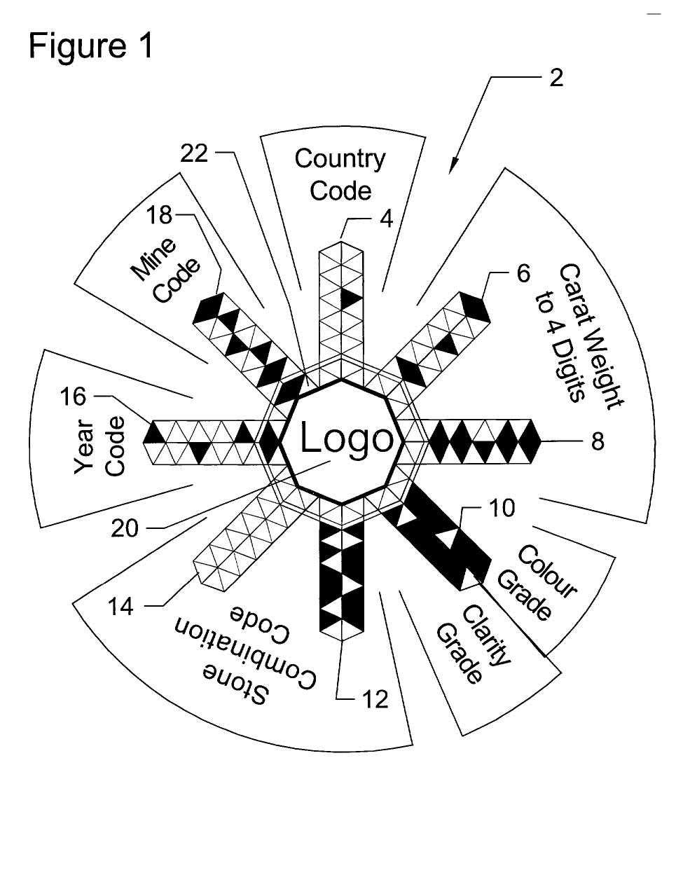

Turning to FIG. 1, wherein like numerals depict the same elements throughout, and which figure illustrates a direct electromagnetic energy transmittal apparatus, there is provided at 2 one type of gemstone profiling apparatus comprising a solid state laser diode 4 and microscope 5 which co-operates with optical arrangements 6 and 7 to produce a collimated focussed laser light beam 8. Gemstone 10 is secured within holding means 12, which is operably connected to integrated data collecting system 9. This collecting system additionally receives positional data with respect to laser 4, microscope 5, parabolic signal collector dish 25 (which captures all signals for detector 26) and optical arrangements 6 and 7 and relays such data to computer system 30 via input/output signal 29.

Light beam 8 is directed to the location of inclusions 15, 16 and 18 and 20 within gemstone 10 and to point of assessment 22. The control and focus of light beam 8 relative to the desired targets may be achieved in a number of different ways. In one embodiment, a means to manipulate collector dish 24 may be used to align and focus the beam correctly by the manipulation of parabolic signal collector dish 25. In another embodiment, holding means 12 may be provided with a repositioning means (not shown) to align gemstone 10 as desired. In yet another embodiment, optical arrangements 6 and 7, microscope 5 and laser 4 may be positionally manipulated (means not shown). All of these repositioning means may be controlled in a feedback loop to computer system 30 through integrated data collecting system 9.

With reference to inclusion 20 through point of assessment 22, transmitted light source 14 produces transmitted light trace 11. Reflected light source 19 produces reflected light trace 17. Beam 23 is the emitted/reflected laser trace from inclusion 20 which reflects off parabolic signal collector dish 25 and is collected by detector 26.

Detector 26 is positioned to receive the electromagnetic energy irradiated, emitted or reflected by the gemstone. Detector 26 produces an output signal 28 which is fed to computer 30. The processing software of computer system 30 allows the processing and storage of the inclusion orientation data described further below.

Within this embodiment, in a most preferred form, the laser beam is selected from any lights within the electromagnetic spectrum, including, but not limited to those which are infra-red, ultra-violet, x-rays and gamma rays. Most preferred are those which are infrared (generally considered to be light with wavelength longer than 780 nm).

Within this embodiment, in a preferred form, optical arrangement 6 is an objective lens and optical arrangement 7 comprises a prism or dichroic mirror to focus beam 8 through this objective lens. Accordingly, the same objective lens is used for microscope 5 and laser 4. In addition, the microscope may provide for a camera to record permanent or semi-permanent images of the gemstone, such images being relayed to computer system 30 via integrated data collecting system 9. In this way, the beam 8 provides a visual “pointer” to the location of each of the selected inclusions. In a further preferred embodiment, microscope 5 comprises binocular lenses, and likewise optical arrangements 6 and 7 are in binocular form to allow for stereoscopic inspection.

In a preferred form, the microscope provides magnification of at least 10 power for use with the image recording device described further below. It is preferred that the microscope provide a magnification of at least 30 power for “selection” of the inclusions and the points of assessment to be surveyed in accordance with the present invention.

Indirect Electromagnetic Energy Transmittal Apparatus/Point Probing Scanner

In general, this apparatus comprises at least one galvanometric scanner capable of scanning the gemstone through defined points of assessment by minute depth increments using a focussed laser beam deflected in two perpendicular planes, a photomultiplier to detect electromagnetic energy irradiated by the scanned gemstone in the form of electrical signals and a means to digitize the electrical signals, thereby creating a profile or 3-D model of selected inclusions within said gemstone, said profile or model reflecting the orientation of each inclusion relative to the points of assessment.

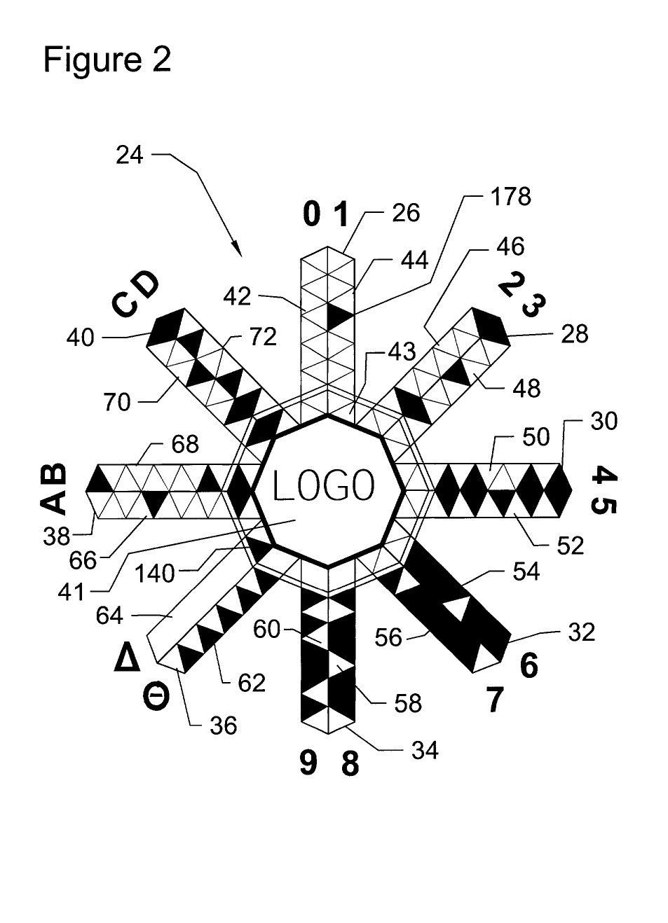

Turning to FIG. 2, wherein like numerals depict the same elements throughout, and which figure illustrates an indirect electromagnetic energy transmittal apparatus, there is provided at 32 one type of gemstone profiling apparatus comprising a solid state laser 34 which co-operates with beam expander 36 and 38 to produce laser beam 40. Laser beam 40 is reflected on dichroic mirror or beamsplitter 42 to produce reflected beam 44 which is then focussed by microscope objective 46 onto gemstone 48. More specifically, gemstone 48 is secured within immersion fluid 52 in holding means 50. Reflected beam 44 is directed to detection zone 54. Thereafter, energy is irraditated from gemstone 48 in the form of beam 56, which is transmitted through dichroic mirror 42, through pinhole 58 and emission filter 60. Pinhole 58 is arranged in front of detector 62, on a plane conjugate to the focal plane of objective 46. Energy irradiated from planes above or below the focal plane will be out of focus when it reaches pinhole 58.

Detector 62 is positioned to receive the electromagnetic energy irradiated by the gemstone. Detector 62 produces an output signal 64 which is fed to computer 66. The processing software of computer system 66 allows the processing and storage of the inclusion orientation data and the formation of a 3-D profile, model or survey of the gemstone as described further below.

The embodiment of FIG. 2 illustrates one example of a “point probing scanner” wherein the gemstone is scanned for inclusions point-by-point. An example of such a scanner is the confocal laser scanning microscope (“LSM”). In essence, the gemstone is irradiated in a pointwise fashion wherein beam 44 is manipulated across gemstone 48 or the gemstone is manipulated relative to beam 44. “Slices” of the gemstone are “cut” and recorded at different planes while either the gemstone is moved along axis z by controlled increments or while beam 44 is moved relative to the gemstone. Detector 62 (for example, a phototmultipier) registers the spatial changes of object properties I(x) as a temporal intensity fluctuation I(t). Spatial and temporal co-ordinates are related to each other by the speed of the scanning process (x=t•v . . . ). The detector converts the optical information into electrical information. The continuous electrical signal is periodically sampled by an analog-to-digital (A/D) converter and thus transformed into a discrete, equidistant succession of measure data (pixels).

Confocal LSM technology offers great advantages in the gemstone modeling or 3-D profiling method of the present invention. A confocal imaging system achieves out-of-focus rejection by two strategies: a) by illuminating a single point of the gemstone at any one time with a focussed beam, so that illumination intensity drops off rapidly above and below the plane of focus and b) by the use of blocking a pinhole aperture in a conjugate focal plane to the gemstone so that light emitted away from the point in the gemstone being illuminated is blocked from reaching the detector. Confocal imaging can offer another advantage in gemstone analysis (small pinhole size, bright specimen): the resolution that is obtained can be better by a factor of up to 1.4 than the resolution obtained with the microscope operated conventionally.

In general, a confocal microscope that is set up correctly will always give a better image than can be obtained with a standard epifluorescence microscope. All this improvement essentially comes from the rejection of out-of-focus interference. The improvement can vary between marginal to spectacular. Within the scope of the present invention, it is possible to distinguish any interior gemstone detail and obtain a perfectly clear image of an optical section using confocal imaging. References useful in explaining further the confocal LSM technology include: Confocal Laser Scanning Microscopy, Principles, by Carl Zeiss. Examples of companies which manufacturer this microscope and accompanying software include Leica Microsystems and Carl Zeiss Inc.

It is preferred that the confocal LSM have a magnification of between 10 and 200 power.

General

In a most preferred form, detectors 26 and 62 are any devices which adequately detect and collect the energy emitted, irradiated or reflected (with or without the use of collector dishes or mirrors) and which then are used, in connection with appropriate computer systems and software to provide a 3-D model or survey of the selected inclusions. Suitable detectors include digital recording devices, cameras such as a CCD (charge couple device) video cameras, photomultipiers (PMT) and the like.

In one preferred form, holding means 12 and 50 are vessels comprising immersion fluid 21 and 52 respectively, in which the gemstone under examination may be completely submersed and secured. The immersion fluid may be any material which decreases the degree of refraction of the light beams. When light passes from a medium of low optical density, such as air, into a medium of high optical density such as a gemstone, the light is said to be bent toward the normal. The relative ability of a gemstone to bend or refract light is called its' refractive index or RI. Diamonds have an RI of 2.42 meaning that light travels in air at a velocity 2.42 times faster than its' velocity within the diamond, the latter being approximately 77,000 miles per second. Accordingly, the RI is a measure of optical density: the higher the RI, the greater degree of bending. The immersion fluid serves to “decrease” the degree of bending thereby allowing greater accuracy in beam placement. Additionally, the provision of immersion fluid in the examination and modelling of rough irregularly-surfaced gemstones provides a uniform surface, in the form of meniscus 53 (shown in FIG. 2), through which beams 8 and 44 may pass.

Holding means 12 and 50 may provide a motorized scanning stage providing an ability to move the gemstone over four degrees of motion and, optionally for holding means 12, one axis of rotation. This scanning stage may be controlled by integrated data collecting system 9 or the equivalent system in FIG. 2 (not shown).

The processing software of computer systems 30 and 66 allows for the processing and storage of the inclusion orientation data and the formation of a 3-D profile, model or survey of the gemstone. This software may optionally allow for the storage and processing of data related to other physical attributes of the gemstone, including, but not limited to, the chemical profile of selected inclusions and the colour and morphology of selected inclusions. What is achieved, within the scope of this invention, is the attachment of numerous fields of useful identifying information to each selected gemstone inclusion.

The apparatus in FIGS. 1 and 2 may additionally comprise one or more image recording devices such as cameras, video recorders or digital video recorders. These devices are configured to record permanent or semi-permanent images through one or more points of assessment on the gemstone, preferably under a magnification of at least 10 power. The photographic or video data may be compiled and stored in computer systems 30 and 66 and used subsequently, along with the geo-spatial data and optionally the inclusion chemistry data, to identify and track the gemstone. These image recording devices may be part of the microscope 5, solid state laser 34 or detectors 26 and 62.

It is contemplated that the apparatus of the present invention for measuring and recording the geo-spatial point analysis of one or more selected inclusions within a gemstone relative to one or more points of assessment situated on or within said gemstone, may additionally comprise a means to characterize the “chemistry” of the selected inclusions. The chemical analysis or signature so provided may be stored in computer systems 30 or 66 furthering the profile of the selected inclusions. Technology is available already for chemical profiling of gemstone inclusions and includes microprobes such as the confocal Raman microprobe or equivalent.

Analysis of Method

It is to be understood that the method of the present invention may be applied to rough gemstones, those in any stage of manufacturing, and polished gemstones. In the case of diamonds, this includes rough diamonds, marked diamonds, those with one or more windows polished in the rough gemstone, sawn diamonds, bruted diamonds and brillianteered/polished diamonds. It is contemplated that one or more of the preferred methods of the present invention will be conducted by various parties throughout the chain of title of a particular gemstone. For example, a mining company may conduct an analysis of a rough gemstone to give it a first original model or profile, a copy of which would then be carried downstream throughout all subsequent manufacturing steps, perhaps ultimately to the consumer. A government undertaking a certification and monitoring program of diamonds mined within its' jurisdiction may produce a second model or may have manufacturers produce a second model of the sawn parts of the rough gemstone (in the case of diamonds, the top and bottom). This model of the top and bottom should correlate with the “parent” gemstone and may again be carried downstream to the consumer providing an indisputable history as to the origin of the rough gemstone.

In essence, the method of identifying a gemstone of the present invention comprises measuring the distance to and location of (the geo-spatial co-ordinates of) one or more selected inclusions within said gemstone relative to one or more points of assessment and collecting, compiling and analyzing data on the orientation of the selected inclusions thereby forming an 3-D identification profile or model.

With respect to a rough gemstone, this may involve, as an initial step, polishing one or more viewing windows in the rough crystal. With respect to the point probing scanning technology, such a viewing window may not be strictly required, although it is preferred so as to inspect the rough gemstone, to note significant inclusions and their characteristics and optionally to record images of the same under magnification, as an additional tool in the identification portfolio.

Accordingly, the gemstone, whether through the rough viewing window or through any facet of the polished crystal, may be inspected for obvious inclusions, visible, most preferably, under at least 10 power magnification. In a most preferred form, a scanning image across the gemstone is recorded by videography and stored in a computer system which thereafter generates a list of selected “targets”. These targets are understood to be:

1) at least one point of assessment on or within a gemstone which is either a defined area within a polished window on a rough gemstone or is selected from the group consisting of: any surface or facet of a gemstone, any feature of a gemstone such as, for example, an area of relief or elevations on or within the gemstone, an area having inequalities of the crystal surface and subsurface features, or any location of natural and artificial objects such as an inclusion, a label, a logo, a mark, a text section, a number, a trademark, a serial number, a name, a company and an icon; and

2) at least one inclusion.

It should be understood, however, that these targets can be chosen visually under magnification by the operator of the method without computer intervention. Although any inclusion can be selected for the geo-spatial 3-D profiling or modeling in accordance with the present invention, guidelines for choosing the most suitable inclusions include:

1) with respect to a rough gemstone (particularly a diamond), there should be a selection of inclusions in areas which will become the top and bottom once sawed;

2) inclusions with unique morphologies should be selected;

3) inclusions in locations unlikely to be removed during manufacturing should be selected; and

4) light solid inclusions should be selected over dark inclusions.

The number of selected inclusions may vary from at least one to any desired number. In a preferred form, from three to eight inclusions are selected.

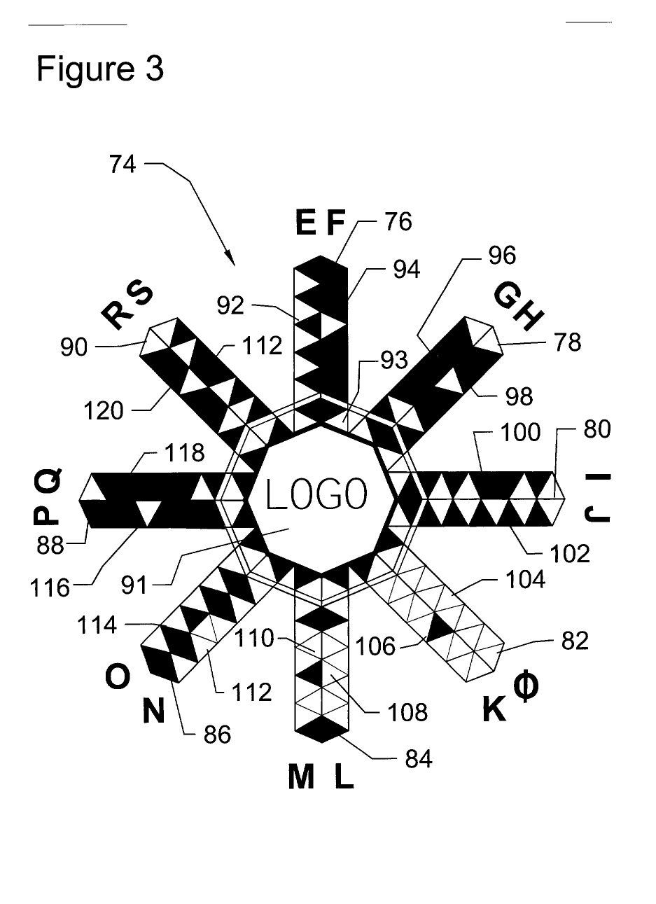

One of the points of assessment so chosen will serve as the co-ordinate “origin” or point, 0,0,0 on the Cartesian co-ordinate system, as explained further below. With reference to FIG. 3, there is provided on gemstone 68 several areas and features which serve as points of assessment (70,72,73,75,77) with 70 being the point of origin and several selected inclusions (74,76,78).

There are three preferred means by which the geo-spatial co-ordinates of each selected point of assessment and each inclusion may be measured. Firstly, and with reference to FIG. 1, the distance measurements may be determined by a direct electromagnetic energy/reflection transmittal apparatus.

Secondly, and also with reference to FIG. 1, if microscope5/optical arrangement 6 (objective) are attached to a common co-ordinate system, the focal length can be used to calculate (using trigonometric calculations) the distance measurements to the points of assessment and inclusions. Focal length is the distance from the lens of the microscope or mirror (as in optical arrangement 6) and its focus (specimen). Generally, the shorter the focal length, the greater the magnification at a given image distance.

More particularly, a sensor may be provided on the positioning equipment or objective lens (not shown in FIG. 1) to record and manipulate the focal length and angles (through fine rotation). The electromagnetic energy reflection/detection apparatus similarly shown in FIG. 1 would be a means thereafter to confirm the data collected by using focal length measurements.

Thirdly, and with reference to FIG. 2 the distance measurements may be determined by point probing scanning technology.

The data relating to the geo-spatial co-ordinates (angles of and distances to the points of assessment and the inclusions) is collected, compiled and analyzed by a monitoring system. This system, in most cases, includes a computing device such as a microprocessor, an arithmetic logic unit (ALU) or any other device capable of processing data information. In a preferred form, this system processes the geo-spatial data into 3-D models. Accordingly, this data can be “triangulated” using any conventional algorithm such as Delaunay's algorithm. One skilled in the art will recognize that other algorithms may be used. Textural data may be applied to the triangulated structure by using, for example, True Space, a software commercially available from Caligary, Mountain View Calif. Generally, textural data comprises information such as the physical properties of the inclusion or point of assessment and may also comprise colour information.

Triangulation is widely employed in the area of land or structure surveying. A triangulation system comprises a series of triangles so connected that, having measured the angles of the triangle and the length of one line, the length of the other lines may be computed. The line of known length, upon which all computed distances are based, is called the base line. The sum of all angles in a triangle is 360° and in any triangle, the lengths of the sides should be proportional to the sines of the angles opposite. Accordingly, if any two angles in a triangle are known, the third angle and side distance lengths can readily be calculated. What is achieved within the scope of the present invention is the use of triangulation systems to map or model the geo-spatial profile of selected inclusions and points of assessment. If one of these points or inclusions are altered or removed during manufacturing or re-cutting, their “location” can be ascertained by calculation from the remaining inclusions or points. This way, no matter how a gemstone is manipulated, short of complete destruction, the 3-D model of the geo-spatial inclusion co-ordinates can always be used to trace, verify and identify it. A good source of information regarding triangulation systems is the book: Surveying: Theory and Practise, Davis Foote & Kelly 5^{th} Edition (McGraw-Hill), 1996 New York, the contents of which are incorporated herein by reference.

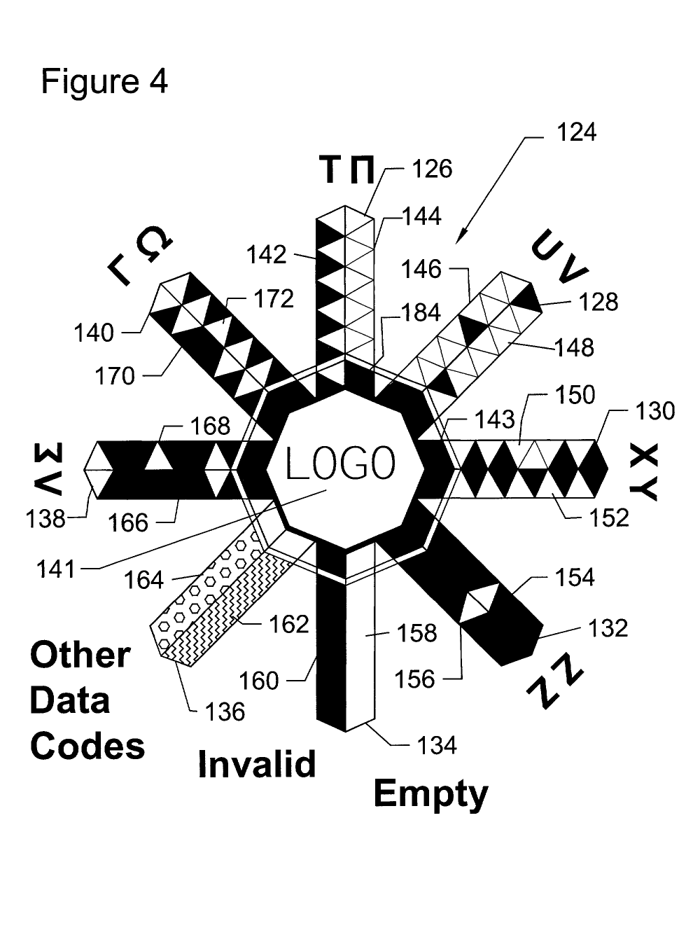

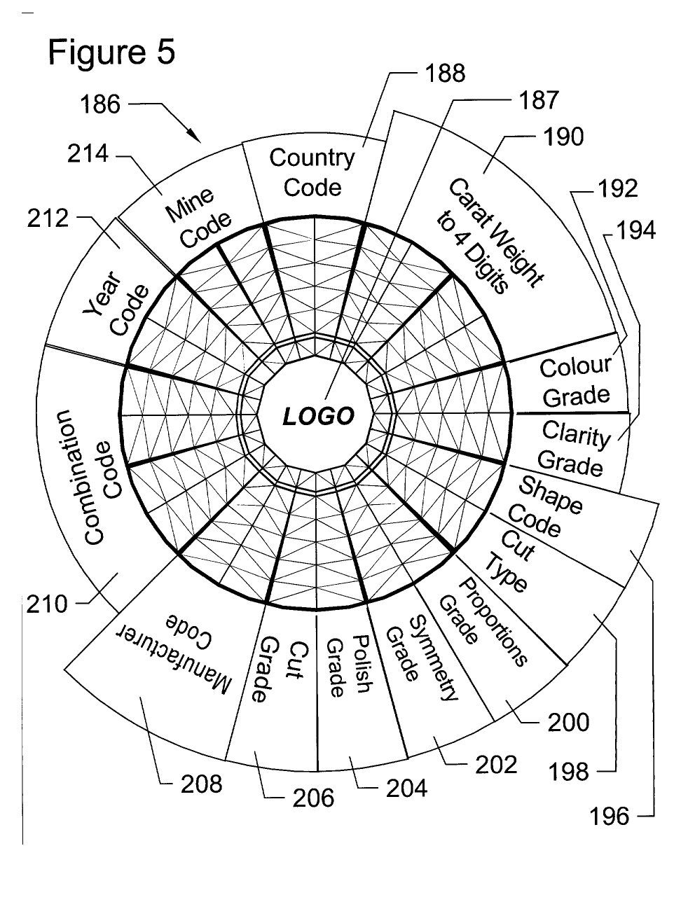

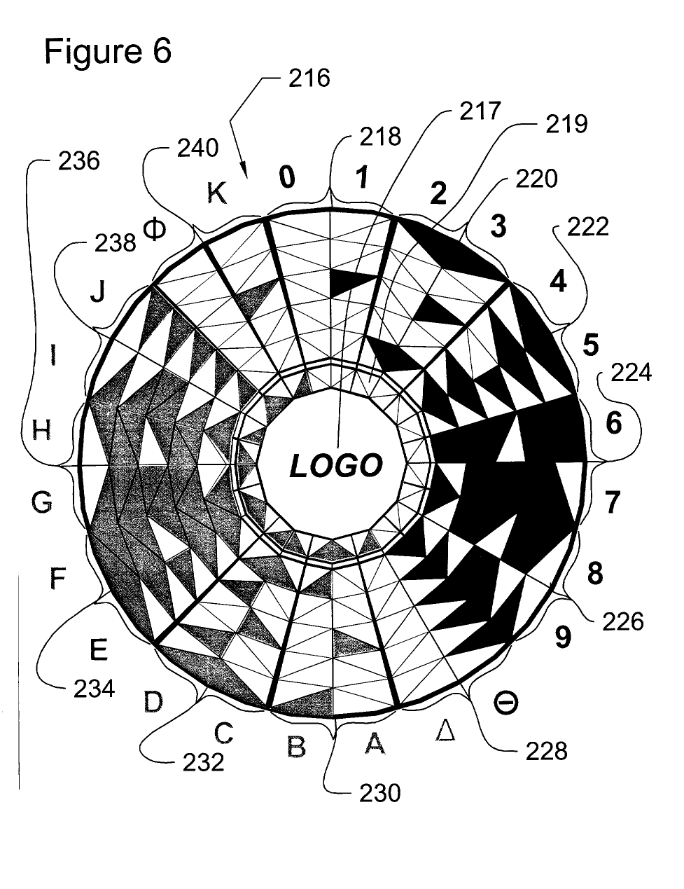

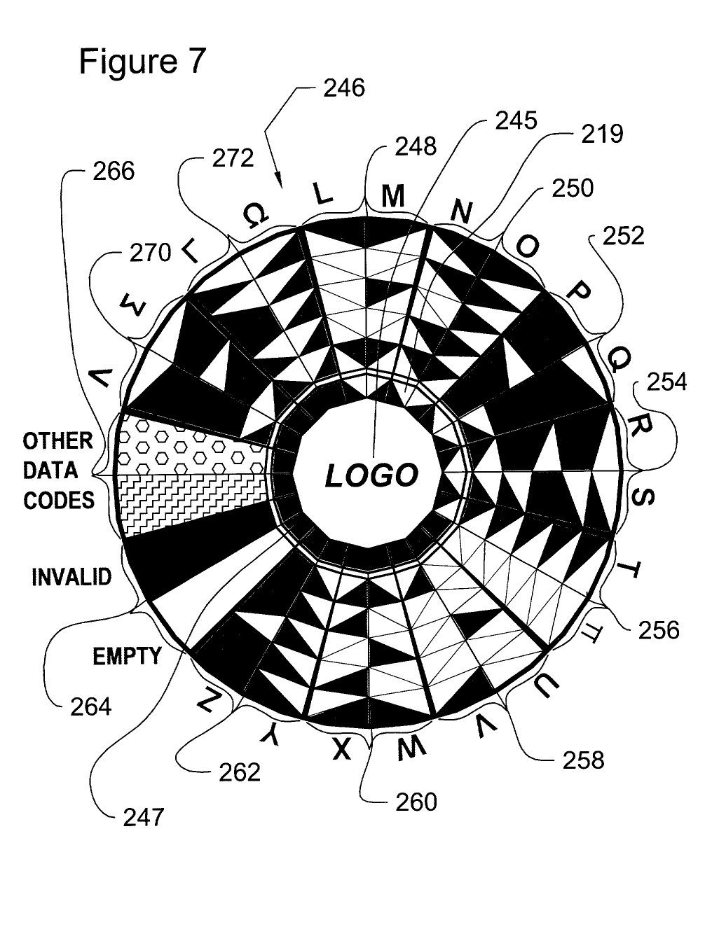

Triangulation is described with reference to FIG. 4, wherein there is provided a gemstone 80. A surface and subsurface visual survey is made of this gemstone to select points of assessment from which is produced a topographic map or model of the crystal. The work of triangulation consists of the following steps, in general, as applied to the present invention:

1) A geo-spatial co-ordinate origin is selected. This origin may be any point on, within or outside of the gemstone. In FIG. 4, a position adjacent to the gemstone (marked ORIGIN, or 0,0,0,) has been selected as the geo-spatial co-ordinate origin in order to keep all co-ordinates in the positive (+) quadrants. Other non-origin points of assessment are selected at 82 (x0,y0,z0), 84 (x1 ,y1 ,z1), 86 (x2,y2,z2), 92 (x5,y5,z5), 96 (x7,y7,z7) and 98 (x8,y8,z8).

2) The angles of and horizontal distances to 82, 84, 86, 92, 96 and 98 are established by one of the methods herein described. Using the Cartesian co-ordinate system, the x, y and z axes emanate from geo-spatial co-ordinate origin (0,0,0).

3) The elevation of points 82, 84, 86, 92, 96 and 98 (i.e. their position on the z axis of the Cartesian co-ordinate system) is determined by the operation of leveling, termed the “vertical control”.

4) The horizontal location (x and y axis co-ordinates) and elevation (z axis coordinates) of inclusions 88 (x3,y3,z3), 90 (x4,y4,z4) and 94 (x6,y6,z6) are determined.

5) The angles, distances and elevations are calculated using formulae and algorithms which are known in the surveying field.

6) A topographical 3-D model of the gemstone surface and sub-surface features is created by compiling, analyzing, plotting and digitizing the data.

It is to be understood that the chosen co-ordinate system may be either a Cartesian coordinate system, wherein the geo-spatial co-ordinate origin and axes x, y and z may be chosen arbitrarily or a polar co-ordinate system wherein, similarly, the geo-spatial coordinate origin, the radius, latitude angle, and longitude angle reference are designated arbitrarily.

The present invention further provides a database for electronically storing a plurality of 3-D gemstone profiles or models. It is contemplated that a central unit maintains a database (the “Geo-Spatial Information System” or “GSIS”) for storing:

1) at least an image of or data relating to the 3-D gemstone model as described herein; and

2) optionally one or more recorded images of the gemstone under magnification;

3) optionally the chemical profile of one or more inclusions;

4) optionally information related to characteristics of the gemstone such as the origin, weight, colour and morphology of selected inclusions and in the case of polished gemstones, such as diamonds, the carat weight, the cut, the clarity, and the colour grade.

We claim:

1. An apparatus for obtaining information about inclusion geo-spatial orientation within a gemstone comprising:
a) a means to measure the distance to and location of one or more selected inclusions within said gemstone relative to one or more points of assessment situated on or within said gemstone; and
b) a monitoring system for collecting, compiling and analyzing data provided by a).

2. The apparatus of claim 1 additionally comprising a means to inspect the gemstone for inclusions.

3. The apparatus according to claim 1 additionally comprising a means for holding the gemstone in place.

4. The apparatus according to claim 1 wherein the means for holding the gemstone in place may be adapted to change the orientation of the gemstone.

5. The apparatus according to claim 1 wherein the means to inspect the gemstone provides magnification of the gemstone of at least 10 power.

6. The apparatus according to claim 1 wherein the means to inspect the gemstone provides magnification of the gemstone of at least 30 power.

7. The apparatus according to claim 1 wherein the means to inspect the gemstone comprises a photographic or video recorder.

8. The apparatus according to claim 1 wherein the means to measure employs laser technology.

9. The apparatus according to claim 1 wherein the point of assessment comprises a defined area within a polished window on a rough gemstone.

10. The apparatus according to claim 1 wherein the point of assessment comprises a defined area on or within a gemstone selected from the group consisting of: any surface or facet of a gemstone, a feature of a gemstone, an area of relief or elevations on the gemstone, an area having inequalities of the crystal surface and subsurface features, any location of natural and artificial objects, including, but not limited to inclusions, labels, logos, marks, text sections, numbers, trademarks, serial numbers, names and icons.

11. An apparatus for obtaining information about inclusion geo-spatial orientation within a gemstone comprising:
a) a laser for generating an output beam;
b) a scanning system wherein the laser beam is moved over one or more points of assessment on or within the gemstone or the gemstone is moved spatially to align one or more points of assessment with the output beam; and
c) a monitoring system for automatically reviewing data from the laser, said data providing geo-spatial co-ordinates of one or more selected inclusions relative to the points of assessment, said monitoring system measuring the distance to and location of each selected inclusion.

12. The apparatus according to claim 11 wherein the monitoring system additionally tracks and measures:
a) the angular position of the laser beam; or
b) the angular position of the gemstone relative to the laser beam.

13. The apparatus of claim 11 additionally comprising a means to inspect the gemstone for inclusions.

14. The apparatus according to claim 11 additionally comprising a means for holding the gemstone in place.

15. The apparatus according to claim 11 wherein the means for holding the gemstone in place may be adapted to change the orientation of the gemstone.

16. The apparatus according to claim 11 wherein the means to inspect the gemstone provides magnification of the gemstone of at least 10 power.

17. The apparatus according to claim 11 wherein the means to inspect the gemstone provides magnification of the gemstone of at least 30 power.

18. The apparatus according to claim 11 wherein the means to inspect the gemstone comprises a photographic or video recorder.

19. The apparatus according to claim 11 wherein the point of assessment comprises a defined area within a polished window on a rough gemstone.

20. The apparatus according to claim 11 wherein the point of assessment comprises a defined area on or within a gemstone selected from the group consisting of: any surface or facet of a gemstone, a feature of a gemstone, an area of relief or elevations on the gemstone, an area having inequalities of the crystal surface and subsurface features, any location of natural and artificial objects, including, but not limited to inclusions, labels, logos, marks, text sections, numbers, trademarks, serial numbers, names and icons.

21. The apparatus according to claim 11 wherein the laser is selected from the group consisting of infra-red, ultra-violet, x-rays and gamma rays.

22. An apparatus for obtaining information about inclusion orientation within a gemstone comprising:
a) at least one galvanometric scanner capable scanning the gemstone through one or more defined points of assessment on or within said gemstone by minute depth increments using a focussed laser beam deflected in two perpendicular planes;
b) photomultiplier to detect electromagnetic energy irradiated by the scanned gemstone in the form of electrical signals; and
c) means to digitize the electrical signals, thereby creating a 3-D profile of selected inclusions within said gemstone, said profile reflecting the geo-spatial orientation of each inclusion relative to the point of assessment.

23. The apparatus of claim 22 additionally comprising a means to inspect the gemstone for inclusions and points of assessment.

24. The apparatus according to claim 22 additionally comprising a means for holding the gemstone in place.

25. The apparatus according to claim 22 wherein the means for holding the gemstone in place may be adapted to change the orientation of the gemstone.

26. The apparatus according to claim 22 wherein the means to inspect the gemstone provides magnification of the gemstone of at least 10 power.

27. The apparatus according to claim 22 wherein the means to inspect the gemstone provides magnification of the gemstone of at least 30 power.

28. The apparatus according to claim 22 wherein the means to inspect the gemstone comprises a photographic or video recorder.

29. The apparatus according to claim 22 wherein the point of assessment comprises a defined area within a polished window on a rough gemstone.

30. The apparatus according to claim 22 wherein the point of assessment comprises a defined area on or within a gemstone selected from the group consisting of: any surface or facet of a gemstone, a feature of a gemstone, an area of relief or elevations on the gemstone, an area having inequalities of the crystal surface and subsurface features, any location of natural and artificial objects, including, but not limited to inclusions, labels, logos, marks, text sections, numbers, trademarks, serial numbers, names and icons.

31. A method of creating a unique 3-D identification model for a gemstone, which model may be used to track the gemstone from rough to polished, comprising the steps of:
a) measuring the distance to and location of one or more selected inclusions, within said gemstone relative to one or more points of assessment on or within said gemstone; and
b) collecting, compiling and analyzing data on the orientation of the selected inclusions thereby forming an identification model.

32. The method of claim 31 wherein data related to the distance to and location of each selected inclusion and point of assessment is compiled by a point probing scanner.

33. The method of claim 31 wherein data related to the distance to and location of each selected inclusion and point of assessment is compiled by a laser technology.

34. The method of claim 31 wherein data related to the distance to and location of each selected inclusion and point of assessment is compiled by focal point analysis.

35. The method of claim 31 wherein data related to the distance to and location of each selected inclusion is compiled by a confocal microscope system.

36. The method of claim 31 additionally comprising the step of inspecting the gemstone under magnification for inclusions prior to step a).

37. The method of claim 36 wherein the gemstone is inspected at a power of at least 10× magnification.

38. The method of claim 36 wherein the gemstone is inspected at a power of at least 30× magnification.

39. The method of claim 36 wherein the gemstone is inspected using a photographic or video recorder.

40. The method of claim 31 wherein the point of assessment comprises a defined area within a polished window on a rough gemstone.

42. The method of claim 31 wherein the point of assessment comprises a defined area on or within a gemstone selected from the group consisting of: any surface or facet of a gemstone, a feature of a gemstone, an area of relief or elevations on the gemstone, an area having inequalities of the crystal surface and subsurface features, any location of natural and artificial objects, including, but not limited to inclusions, labels, logos, marks, text sections, numbers, trademarks, serial numbers, names and icons.

43. The method of claim 31 additionally comprising the step of comparing the identification model of one gemstone to one or more identification models of gemstones previously recorded and stored.

44. A recorded 3-D model of a gemstone whenever produced by the method of claim 31.

45. A recorded 3-D model of a gemstone whenever produced by the method of claim 31 comprising a model of the orientation of selected inclusions relative to the points of assessment, said profile being stored digitally.

46. A database (the “Geo-Spatial Information System” or “GSIS”) for storing at least one image of or data relating to the 3-D gemstone model as prepared in claim 31.

47. A database (the “Geo-Spatial Information System” or “GSIS”) for storing:
a) at least one image of or data relating to the 3-D gemstone model as prepared in claim 31;
b) one or more recorded images of the gemstone under magnification;
c) a chemical profile of one or more inclusions;
d) information related to characteristics of the gemstone including the origin, weight, colour and morphology of selected inclusions, the carat weight, the cut, the clarity, and the colour grade.
